(19) United States
(12) Patent Application Publication
(10) Pub. No.: US 2021/0038045 A1
(43) Pub. Date: Feb. 11, 2021

(54) Exterior Wall Maintenance Apparatus

(71) Applicant: Elid Technology International Pte Ltd, Singapore (SG)

(72) Inventor: Hui Eng LIM, Singapore (SG)

(21) Appl. No.: 16/984,169

(22) Filed: Aug. 4, 2020

(30) Foreign Application Priority Data
Aug. 5, 2019 (SG) 10201907223Y

(51) Int. Cl. A47L 11/38; E04G 3/30; A47L 11/40; B25J 18/00; B25J 19/02

(52) U.S. Cl. CPC A47L 11/38; E04G 3/30; A47L 11/4011; E04G 1/22; B25J 18/00; B25J 19/023; A47L 11/4036

(57) ABSTRACT

The present invention provides an exterior wall maintenance apparatus. In certain embodiments, the exterior wall maintenance apparatus comprises a suspension means; and a suspended platform, where the suspended platform is physically coupled with the suspension means and the suspension means moves the suspended platform vertically and horizontally in parallel to an exterior wall of high rise buildings.

### FIELD OF THE INVENTION

The present invention relates to an exterior wall maintenance apparatus.

### BACKGROUND OF THE INVENTION

Performing maintenances on the exterior walls of high rise buildings has been difficult and hazardous. Fatal accidents have been reported every year for workers carrying out such maintenance. Accidents might be caused by equipment fault or human error, or both.

China patent CN 103784084 B discloses a truck-based dual forces telescopic cylinder automatic cleaning apparatus for cleaning exterior walls of tall buildings, where the automatic cleaning apparatus comprises a truck mounted with a vertical telescopic cylinder and a horizontal telescopic cylinder is mounted to the upper end of the vertical telescopic cylinder, where the horizontal telescopic cylinder is mounted with spraying head and brush for cleaning. However, this automatic cleaning apparatus could not be able to cleanse high rise buildings because of the limited height of its telescopic cylinder. In addition, this automatic cleaning apparatus is not flexible for different surfaces because of the fixed brushes on its horizontal cylinder. This automatic cleaning apparatus is designed for one specific application, and when a separate application is required, a different system is desired.

U.S. Pat. No. 3,775,804 discloses a wall washing device comprising wall and window surface scrubbing means such as brushes or sponges. The pair of reciprocatory oscillating brushes are mounted on a rigid bearing. It is not suitable for all surfaces.

Therefore, it is imperative to provide an apparatus that could perform the maintenance on the exterior walls of high rise buildings, but does not require a maintenance worker to climb high.

### SUMMARY OF THE INVENTION

The present invention provides an exterior wall maintenance apparatus. In certain embodiments, the exterior wall maintenance apparatus comprises a suspension means; and a suspended platform, where the suspended platform is physically coupled with the suspension means and the suspension means moves the suspended platform vertically and horizontally in parallel to an exterior wall of high-rise buildings; wherein the suspended platform comprises a base, a two-axes track, a multi-axes robotic arm, an image capturing means, an exterior wall tooling attachment, a pair of locators, and a platform controller;
wherein the base is physically coupled with the suspension means, and provides physical support for mounted components;
wherein The two-axes track is mounted on the base, and comprises a pair of tracks in one axis so that the pair of tracks enable the multi-axes robotic arm to move away from or close to the exterior wall, and a parallel track in another axis being mounted on the pair of tracks so that the parallel track enables the multi-axes robotic arm to move side-by-side in parallel to the exterior wall;
wherein the multi-axes robotic arm is flexible acted as human arm that can reach any surface in any angle and acted according to the profile of the surface to perform any maintenance operations;
wherein the image capturing means is mounted at the distal end of the multi-axes robotic arm but behind the exterior wall work means to capture the images of the exterior wall and sends the captured images to the platform controller;
wherein the exterior wall tooling attachment is attached to the distal end of the robotic arm;
wherein the pair of locators are equipped at both longitudinal ends of the base 110 for dual functions, preventing the suspension platform from damaging the exterior wall and anchoring the suspension platform when the suspended platform is in position to perform the maintenance work; and
wherein the platform controller is a computer programmable processor that can collect information from the image capturing means and a ground operator, and send instructions the robotic arm, the exterior wall work means and the pair of locators 160 so as to perform the maintenance work on the determined position.

In another embodiment of the exterior wall maintenance apparatus, the suspension means is a gondola.

In another embodiment of the exterior wall maintenance apparatus, the image capturing means is a camera.

In another embodiment of the exterior wall maintenance apparatus, the exterior wall work means is a brush that is in contact with the surface.

The objectives and advantages of the invention will become apparent from the following detailed description of preferred embodiments thereof in connection with the accompanying drawings.

### BRIEF DESCRIPTION OF THE DRAWINGS

Preferred embodiments according to the present invention will now be described with reference to the Figures, in which like reference numerals denote like elements.

FIG. 1a shows a perspective view of the suspended platform in accordance with one embodiment of the present invention.

FIG. 1b shows a perspective view of a robotically operated surface inspection and manipulation system that can be operated in the suspended platform in accordance with one embodiment of the present invention.

FIG. 2 is a flowchart of the workflow of the robotically operated surface inspection and manipulation system in accordance with one embodiment of the present invention.

### DETAILED DESCRIPTION OF THE INVENTION

The present invention may be understood more readily by reference to the following detailed description of certain embodiments of the invention.

Throughout this application, where publications are referenced, the disclosures of these publications are hereby incorporated by reference, in their entireties, into this application in order to more fully describe the state of art to which this invention pertains.

The present invention provides an exterior wall maintenance apparatus that is controlled remotely. The exterior wall maintenance apparatus enables to perform the maintenance on the exterior walls of highrise buildings but does not require the maintenance worker to climb high.

The exterior wall maintenance apparatus comprises a suspension means and a suspended platform, where the suspended platform is physically coupled with the suspension means and the suspension means moves the suspended platform vertically and horizontally in parallel to an exterior wall of high rise buildings. The suspension means can be a gondola as disclosed in our earlier invention (WO 2017/171644 A1, titled “SYSTEM AND METHOD FOR CLEANING EXTERIOR WALL OF BUILDING”), a suspended hoist, or any other suitable means.

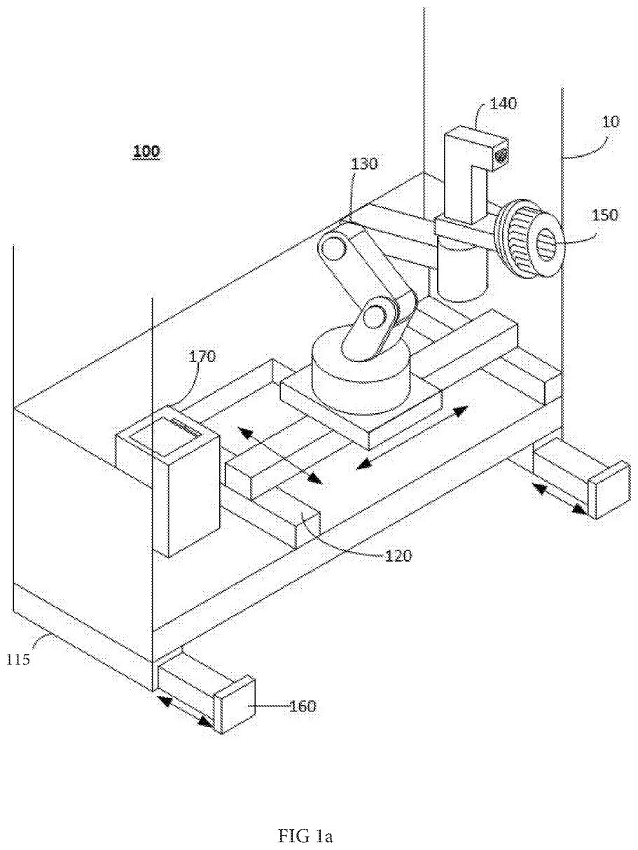

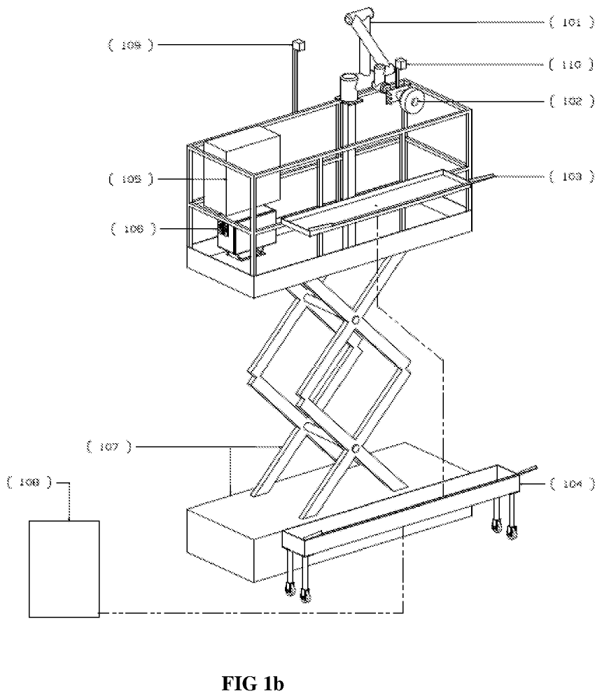

FIG. 1a illustrates a perspective view of the suspended platform in accordance with one embodiment of the present invention. The suspended platform 100 is physically coupled with a suspension means 10 (details not shown). The suspended platform 100 comprises a base 115, a two-axes track 120, a multi-axes robotic arm 130, an image capturing means 140, an exterior wall tooling attachment 150, a pair of locators 160, and a platform controller 170.

The base 115 is physically coupled with the suspension means, and provides physical support for mounted components. Any material with requisite strength can be suitable.

The two-axes track 120 is mounted on the base 115, and comprises a pair of tracks in one axis so that the pair of tracks enable the multi-axes robotic arm 130 to move away from or close to the exterior wall, and a parallel track in another axis being mounted on the pair of tracks so that the parallel track enables the multi-axes robotic arm 130 to move side-by-side in parallel to the exterior wall. The movement of the parallel track over the pair of tracks can be implemented by any suitable means, e.g. a pulley. It is well known in the art.

The multi-axes robotic arm 130 is flexible acted as human arm that can reach any surface in any angle and acted according to the profile of the surface to perform any maintenance operations, such as cleaning.

The image capturing means 140 is mounted at the distal end of the multi-axes robotic arm 130 but behind the exterior wall work means 150 to capture the images of the exterior wall and sends the captured images to the platform controller, so that the platform controller is able to determine the position of the maintenance to be done, and then sends instructions to the robotic arm 130 to perform the maintenance work on the determined position. In certain embodiments, the image capturing means 140 can be a camera.

The exterior wall tooling attachment 150 is attached to the distal end of the robotic arm 130. In certain embodiments, the exterior wall work means 150 is a brush that is in contact with the surface. Other brushes and tooling can also be used. Such as roller brushes, surface filler/sander, etc.

The pair of locators 160 are equipped at both longitudinal ends of the base 115 for dual functions, preventing the suspension platform 100 from damaging the exterior wall and anchoring the suspension platform 100 when the suspended platform 100 is in position to perform the maintenance work.

The platform controller 170 is a computer programmable processor that can collect information from the image capturing means 140 and a ground operator, and send instructions the robotic arm 130, the exterior wall work means 150 and the pair of locators 160.

The present invention also provides a method of performing maintenance work on an exterior wall of highrise buildings using the exterior wall maintenance apparatus as described above.

FIG. 1b illustrates a perspective view of the robotically operated surface inspection and manipulation system that can be operated in the suspended platform as described above in accordance with one embodiment of the present invention. The components and corresponding numerical references are summarized hereinbelow:

101 Robotic arm

102 Robot manipulation module

103 Upper Tray

104 Water Container

105 Control Box

106 Robot Control Box

107 Scissor Lift Module

108 Recycle Water Container

109 3D Sensor A

110 3D Sensor B

Referring still to FIG. 1b, the scissor lift module 107 comprises a lower foundation, a middle scissor lift with a lower end and an upper end, and an upper platform, where the lower end of the middle scissor lift is mounted on the lower foundation, and the upper platform is mounted on the upper end of the middle scissor end. The upper tray 103 is mounted on the upper platform of the scissor lift module 107. The upper tray 103 is foldable with a rubber edge; when it is in use, the upper tray 103 will open and the rubber edge will contact wall facade. The water container 104 is beneath the upper tray 103 and situated on the ground. The upper tray 103 and the water container 104 are connected by a water hose. Water collected by the upper tray 103 will flow to the water container 104 through the water hose. The underneath of the water container 104 is attached with a plurality of omni wheels (4 such wheels are shown). The water container 104 can move with the scissor lift module 107 during the washing process. The recycled water will be contained in the recycle water container 108.

Referring still to FIG. 1b, the robotic arm 101 is disposed on the top of the upper platform of the scissor lift module 107.

The robot manipulation module 102 comprises a grinding-force/torque sensor, a plastering-force/torque sensor, and a sanding-force/torque sensor. The grinding-force/torque sensor is used to calculate real-time grinding force which is applied on the detected protrusion region. The robot manipulation module 102 will apply a constant force and appropriate speed while executing grinding action. The plastering-force/torque sensor is used to calculate real-time plastering force which is applied on the detected hole. The robot manipulation module 102 will apply a constant force and appropriate speed while applying plaster cast to the detected hole. The sanding-force/torque sensor is used to calculate real-time sanding force which is applied on the detected protrusion region. The robot manipulation module 102 will apply a constant force and appropriate speed while executing sanding task. The robot manipulation module 102 further comprises a set of tools for grinding, plastering and sanding; the robot manipulation module 102 also comprises an automatic tool changer that enables the set of tools to be changed automatically by applying an auto-tool-changing algorithm.

The automatic tool changer comprises two parts: a Tool Master (robot side) and a Tool Slave Adapter (tool side). There is only one Tool Master and it is installed firmly on the robot TCP (tool center point) by using screws. There are 3 pins on the Tool Master plate which act as a rotational lock for attach/detach purpose to connect the Tool Slave Adapter. Each tool come with one Tool Slave Adapter, one end of it holding the tool and the other end comprises 3 unique holes which match the pattern of 3 pins on tool master for connection purpose. Each Tool Slave Adapter sits on their own Tool Rail. The Tool Rail is designed in such a manner that the Tool Slave Adapter can only be removed from its position from one horizontal direction.

The robot arm 101 will send the Tool Master to the top position of the desired Tool Slave Adapter. The 3 pins are inserted precisely into the 3 unique holes on the Tool Slave Adapter. The end effector of robot will then rotate in clockwise direction in order to lock and connect the two parts. The robot arm 101 will then move in one horizontal direction of the Tool Rail to bring out the Tool Slave Adapter and the tool is ready to be used.

For detachment of the Tool Slave Adapter, the robot arm 101 will send the Tool Slave Adapter back to its Tool Rail and rotate in counter clockwise direction to unlock the 3 pins connector. Robot arm will then lift up and perform other tasks.

The robotically operated surface inspection and manipulation system comprises a vision and analysis module. As shown in FIG. 1b, the vision and analysis module comprises two 3D sensors are included to capture real-time environment information (e.g. Wall point cloud). Duo-sensor multi-view analyzing is adopted to increase real-time point cloud and image processing speed. The 3D Sensor A 109 is disposed on the upper platform of the scissor lift module 107 to capture a static view of a wall to obtain a wall static view. The wall static view is an overall picture of the wall condition captured after each platform movement. The dynamic 3D Sensor_B 110 is disposed on the robotic arm of the robotic manipulation module 101 to capture a dynamic view of the wall to obtain a wall dynamic view. The wall dynamic view is a detailed view of each suspected wall region identified by a Protrusion Detection Algorithm. The Protrusion Detection Algorithm utilizes point cloud analysis techniques and computer vision techniques to identify suspected defect/protrusion region from the wall static view. Raw point cloud is down sampling using Voxel Grid Filter in order to increase the real time calculation speed. Cluster extraction and planar segmentation algorithm is applied. Defect/protrusion region point cloud is extracted. Selected clusters are converted to 2D images to do further image analysis. Machine learning is applied in the image processing step to increase the real time defect/protrusion region identification success rate. 2D-To-3D Coordinate Analysis and Protrusion Orientation Analysis are applied to get back actual coordinate and orientation of defect/protrusion region. If the protrusion has a height that is less than 4 mm, sanding action will be applied. If the protrusion has a height that is less than 8 mm, larger than 4 mm, grinding action will be applied.

For defect identification, distance between the wall and camera, Wa (wall average), is obtained at the beginning. The algorithm will start to search for the region where the different in between Wa and its average wall to camera absolute distance is greater than a threshold, Td. If the difference is in between certain range, the algorithm will instruct robot to do the respective task, eg. grinding, sanding.

The robotic arm and vision share same coordinate. All the tools are customized under the same size. That means the distance between tools and the façade is fixed. Firstly, the 3D camera scans the exterior surface. The data will be processed by the vision algorithm. With the result, the starting point coordinate will be provided to robotic arm. The arm will reach to the particular point accordingly and start the task.

The Control Box 105; the Control box 105 comprises one IPC (Industrial PC), five microcontrollers, motor drivers and sensors communication interface board. This is a real time distribution system. IPC is the master to coordinate the motion of different modules. All the modules are slaves. They are listening the command from the master and act accordingly. The slaves are robot arm, motorized gondola, suction system and pumps. Meanwhile, the master collects information from different sensors for next step.

The Robot Control Box 106; as mentioned earlier, robot is a slave of the real time distribution system. It listens the command from the IPC and act accordingly.

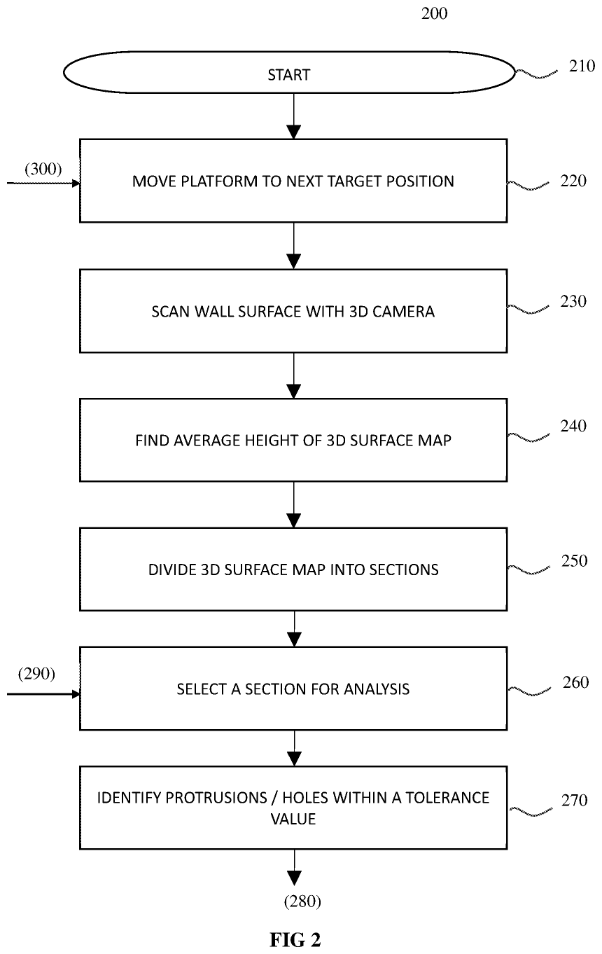

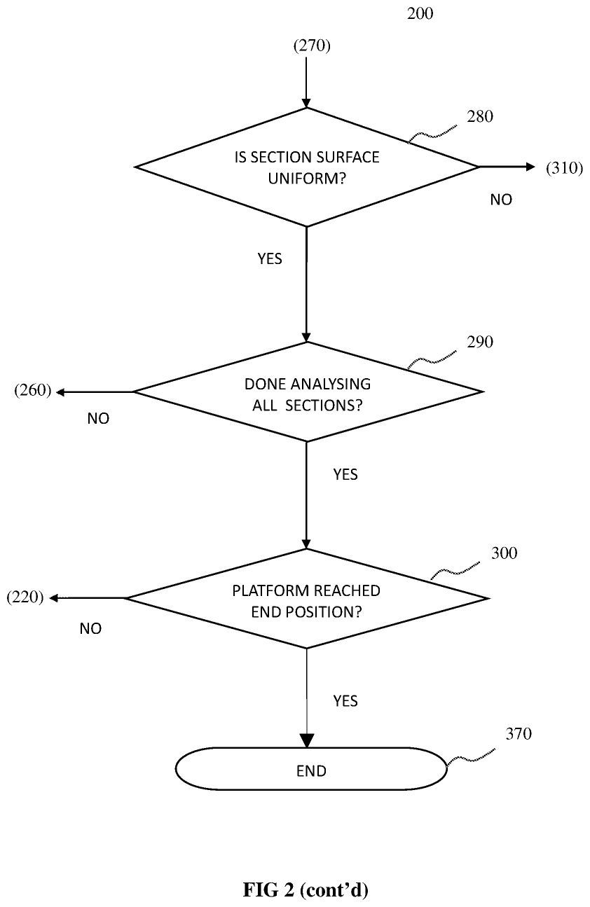

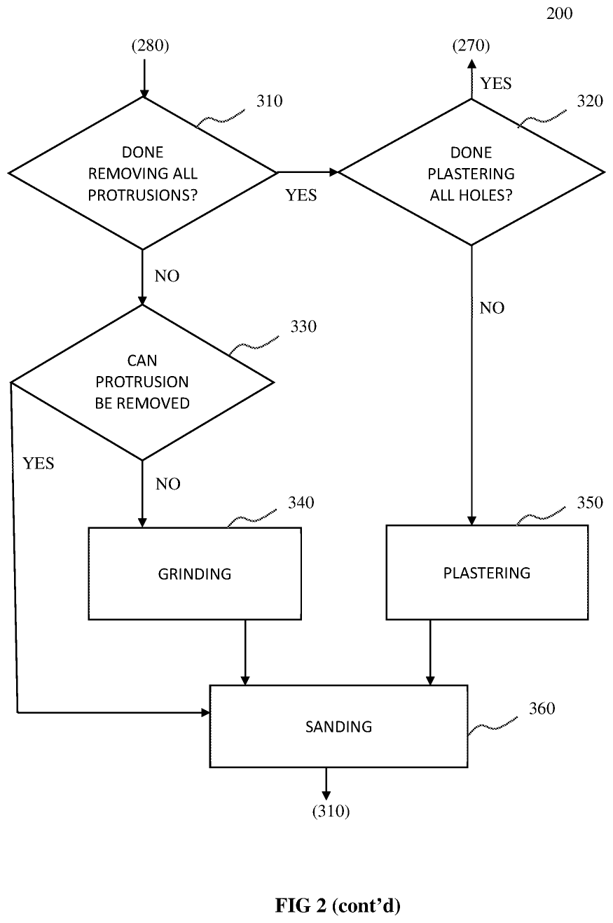

Referring now to FIG. 2, there is provided a flowchart showing the operation of the robotically operated surface inspection and manipulation system in accordance with one embodiment of the present invention. The operation 200 comprises:
at step 210, start the operation;
at step 220, move the platform to next target area;
at step 230, scan wall surface of the target area with 3D Sensor 109 (e.g. camera) to create a 3D surface map;
at step 240, obtain average height of the 3D surface map;
at step 250, divide the 3D surface map into sections;
at step 260, select a section for analysis;
at step 270, identify protrusions and holes within a tolerance value by applying the vision algorithm; if a protrusion dimension is 15 cm×16 cm×17 cm, the camera is able to capture it. Firstly, the algorithm will calculate the distance (17 cm) between façade and the top of the protrusion. Then the area of the top (15 cm×16 cm) will be calculated. Based on the capture result, the multi-axes robotic arm will generate a path to avoid the particular protrusion;
at step 280, decide whether the analyzed section has a uniform surface;
at step 290, if the answer in step 280 is YES, decide whether all sections have been analyzed; if the answer at the step 290 is NO, go back to step 260;
at step 300, if the answer in step 290 is YES, decide whether the platform reaches end position; if the answer is NO, go back to step 220;
at step 370, if the answer in step 300 is YES, end the operation;
at step 310, if the answer in step 280 is NO, decide whether all protrusions are removed;
at step 320, if the answer in step 310 is YES, decide whether all holes are plastered; if the answer in step 320 is YES, go back to step 270;
at step 330, if the answer in step 310 is NO, decide whether the protrusions can be removed by sanding;
at step 340, if the answer in step 330 is NO, perform grinding on the protrusions;
at step 350, if the answer in step 320 is NO, perform plastering on the holes;
at step 360, perform sanding on the protrusions if the answer in step 330 is YES, the grinding of step 340 is done, and the plastering of step 350 is done; after sanding in step 360, go back to step 310.

From the step 310 to the step 360, the dynamic 3D sensor 110 will be activated to analyze the specific protrusion or hole. If the protrusion has a height that is bigger than 4 mm but less than 8 mm, then the grinding action will be activated. If the protrusion has a height that is less than 4 mm, then the sanding action will be activated. If a hole is identified, the plastering action will be activated. After the repair, the 3D sensors 109, 110 will check again. If the repair is not acceptable, the repair process will be activated again until the result is acceptable. Once this target area is done, the system will move to another target area and repeat the cycle above.

While the present invention has been described with reference to particular embodiments, it will be understood that the embodiments are illustrative and that the invention scope is not so limited. Alternative embodiments of the present invention will become apparent to those having ordinary skill in the art to which the present invention pertains. Such alternate embodiments are considered to be encompassed within the scope of the present invention. Accordingly, the scope of the present invention is defined by the appended claims and is supported by the foregoing description.

What is claimed is:

1. An exterior wall maintenance apparatus comprising:
a suspension means; and
a suspended platform, where the suspended platform is physically coupled with the suspension means and the suspension means moves the suspended platform vertically and horizontally in parallel to an exterior wall of highrise buildings;
wherein the suspended platform comprises a base, a two-axes track, a multi-axes robotic arm, an image capturing means, an exterior wall tooling attachment, a pair of locators, and a platform controller;
wherein the base is physically coupled with the suspension means, and provides physical support for mounted components;
wherein The two-axes track is mounted on the base, and comprises a pair of tracks in one axis so that the pair of tracks enable the multi-axes robotic arm to move away from or close to the exterior wall, and a parallel track in another axis being mounted on the pair of tracks so that the parallel track enables the multi-axes robotic arm to move side-by-side in parallel to the exterior wall;
wherein the multi-axes robotic arm is flexible acted as human arm that can reach any surface in any angle and acted according to the profile of the surface to perform any maintenance operations;
wherein the image capturing means is mounted at the distal end of the multi-axes robotic arm but behind the exterior wall work means to capture the images of the exterior wall and sends the captured images to the platform controller;
wherein the exterior wall tooling attachment is attached to the distal end of the robotic arm;
wherein the pair of locators are equipped at both longitudinal ends of the base for dual functions, preventing the suspension platform from damaging the exterior wall and anchoring the suspension platform when the suspended platform is in position to perform the maintenance work; and
wherein the platform controller is a computer programmable processor that can collect information from the image capturing means and a ground operator, and send instructions the robotic arm, the exterior wall work means and the pair of locators so as to perform the maintenance work on the determined position.

2. The exterior wall maintenance apparatus of claim 1, wherein the suspension means is a gondola.

3. The exterior wall maintenance apparatus of claim 1, wherein the image capturing means is a camera.

4. The exterior wall maintenance apparatus of claim 1, wherein the exterior wall work means is a brush that is in contact with the surface.
